(19) United States
(12) Patent Application Publication
(10) Pub. No.: US 2020/0166137 A1
(43) Pub. Date: May 28, 2020

(54) SEAL MEMBER FOR MACHINE TOOL

(71) Applicant: BANDO CHEMICAL INDUSTRIES, LTD., Kobe-shi, Hyogo (JP)

(72) Inventors: Yuki ABE, Kobe-shi, Hyogo (JP); Nariaki IWASAKI, Kobe-shi, Hyogo (JP)

(73) Assignee: BANDO CHEMICAL INDUSTRIES, LTD., Kobe-shi, Hyogo (JP)

(21) Appl. No.: 16/637,316

(22) PCT Filed: Jul. 25, 2018
(86) PCT No.: PCT/JP2018/027951

§ 371 Date: Feb. 7, 2020

(30) Foreign Application Priority Data
Aug. 8, 2017 (JP) 2017-153307

(51) Int. Cl. F16J 15/3204; F16J 15/3284

(52) U.S. Cl. CPC F16J 15/3204; F16J 15/3284

(57) ABSTRACT

A sealing member for machine tools includes a plate-shaped supporting member and a plate-shaped elastic member. The elastic member is attached to the machine tool so as to be sandwiched between an attachment portion of the machine tool and the supporting member. The elastic member is in sliding contact with a sliding surface of the machine tool. The elastic member includes a projecting portion which projects from an edge portion of the supporting member toward a side of the sliding surface of the machine tool such that one surface side of the projecting portion comes into sliding contact with the sliding surface of the machine tool. The projecting portion has a distal edge including a plurality of linear portions. A corner portion is sandwiched between two adjacent linear portions among the linear portions, and is provided with an incision extending from the corner portion toward the supporting member side.

### TECHNICAL FIELD

The present invention relates to a sealing member for machine tools.

### BACKGROUND ART

Machine tools such as a lathe, a machining center, and a cutting machine use a sealing member for machine tools (sometimes referred to as a wiper member) having various shapes for protecting a driving mechanism from chips and a coolant (cutting oil), removing the chips and the coolant, or the like.

A sealing member for machine tools is composed of, for example, a supporting member and an elastic member, in which the elastic member is used so as to be in sliding contact with a predetermined member of a machine tool.

At this time, the machine tool side member which comes into a sliding contact with the sealing member for machine tools has various shapes such as a curved surface. The sealing member for machine tools needs to be attached to the machine tool so as to match a shape of a sliding surface of the machine tool (a surface that the machine tool has and comes into a sliding contact with the sealing member for machine tools) without a gap.

Therefore, there is a case, for example, where end portions of a linear sealing member for machine tools are processed to have a 45° bevel and the processed end portions are abutted to form a sealing member for machine tools for use in a corner portion curved at 90° (see e.g. FIG. 3 in Patent Literature 1).

Other sealing member for machine tools for use in a corner portion which is curved at 90° include a commercially available sealing member for machine tools 50 obtained by molding an elastic member 52 integrally with an L-shaped supporting member 51 as shown in FIG. 7A and FIG. 7B. The sealing member for machine tools produced in accordance with a shape of a sliding surface of a machine tool can be easily attached to the machine tool. Additionally, such sealing member for machine tools tends to have excellent sealability as compared with combined use of a plurality of sealing members for machine tools.

### CITATION LIST

### Patent Literature

Patent Literature 1: Japanese Unexamined Patent Publication No. 2000-42863

### SUMMARY OF INVENTION

### Technical Problem

It is a common practice for the conventional sealing member for machine tools 50 to contact an edge portion 52a of the elastic member 52 when the elastic member 52 contacts a sliding surface (not shown) of a machine tool. In this case, contact of the elastic member 52 with the sliding surface of the machine tool is substantially linear contact. Therefore, the elastic member is liable to wear due to sliding on the sliding surface of the machine tool.

Under these circumstances, in order to make the elastic member be less liable to wear, it has been deliberated to increase a contact surface area between the elastic member and the sliding surface of the machine tool.

By contrast, a non-linear sealing member for machine tools having a shape corresponding to a shape of a sliding surface of the machine tool might involve a fault when an elastic member is designed to have a shape that makes a surface area in contact with the sliding surface be increased. Specifically, since the non-linear sealing member for machine tools cannot appropriately come into a sliding contact with a curved portion (corner portion) of the sliding surface during use, cracks are generated at a corner portion of an elastic member corresponding to a shape of the curved portion of the sliding surface at an early stage. As a result, such a fault as damage to sealability might develop.

### Solution to Problem

The present inventors conducted intensive studies to solve the problems described above, and completed a sealing member for machine tools which can be used for a long period of time because of having excellent sealability while having a shape corresponding to a shape of a sliding surface of the machine tool and because an elastic member hardly wears.

A sealing member for machine tools of the present invention includes a plate-shaped supporting member and a plate-shaped elastic member. The elastic member is attached to the machine tool so as to be sandwiched between an attachment portion of the machine tool and the supporting member, the elastic member being in sliding contact with a sliding surface of the machine tool. The elastic member includes a projecting portion which projects from an edge portion of the supporting member toward a side of the sliding surface of the machine tool, and is configured such that one surface side of the projecting portion comes into sliding contact with the sliding surface of the machine tool. The projecting portion has a distal edge including a plurality of linear portions, and a corner portion sandwiched between two adjacent linear portions among the plurality of linear portions, and is provided with an incision extending from the corner portion toward the supporting member side.

The sealing member for machine tools is configured with a simple structure in which a plate-shaped supporting member and a plate-shaped elastic member are combined. This enables a sealing member for machine tools to be designed corresponding to a shape of a sliding surface of a machine tool with ease.

Also, at the projecting portion provided in the elastic member, the sealing member for machine tools comes into sliding contact with the sliding surface of the machine tool. At this time, the one surface side of the projecting portion comes into sliding contact with the sliding surface of the machine tool, i.e., into so-called surface-to-surface contact. Therefore, the elastic member is less liable to wear.

Further, the projecting portion has the distal edge including the linear portions and the corner portion and is provided with the incision extending from the corner portion toward the supporting member side. It is therefore possible to reliably seal the curved sliding surface by one sealing member for machine tools while avoiding generation of cracks in the corner portion. Accordingly, sealability will not be impaired by damage started at the corner portion or the like.

In the sealing member for machine tools, the elastic member preferably includes thermosetting polyurethane and a μ-lowering agent.

In this case, in combination of excellent wear resistance that thermosetting polyurethane has and an effect of reducing a coefficient of friction obtained by inclusion of the μ-lowering agent, the elastic member in particular becomes less liable to wear.

In the sealing member for machine tools, the projecting portion is preferably provided such that a pressing margin of the linear portion is 3 mm or more.

In this case, a contact state of the linear portion with the sliding surface of the machine tool can be surface-to-surface contact. It is also possible to reliably prevent the projecting portion from inverting at the time of sliding on the sliding surface of the machine tool. Therefore, the above sealing member for machine tools is more appropriate for achieving both excellent sealability and wear resistance.

In the sealing member for machine tools, the projecting portion is preferably provided with a through hole leading to an end portion of the incision at a side opposite to the corner portion.

In this case, this makes cracks in the corner portion and in its vicinity, damages and the like leading from the corner portion to the linear portion be less liable to occur.

### Advantageous Effects of Invention

A sealing member for machine tools of the present invention can be used for a long period of time because of excellent sealability and because an elastic member hardly wears.

### BRIEF DESCRIPTION OF DRAWINGS

FIG. 1A is a plan view showing a sealing member for machine tools according to a first embodiment.

FIG. 1B is a sectional view taken along line A-A of the sealing member for machine tools shown in FIG. 1A.

FIG. 2 is a plan view separately showing a supporting member and an elastic member configuring the sealing member for machine tools shown in FIG. 1A.

FIG. 3 is an enlarged plan view of a main part of the sealing member for machine tools shown in FIG. 1A.

FIG. 4 is a perspective view for explaining a state of contact with a sliding surface of the machine tool when the sealing member for machine tools shown in FIG. 1A is used.

FIG. 5 is an enlarged view of a main part of a cross-section taken along line C-C in FIG. 4 for explaining a state of attachment of the sealing member for machine tools.

FIG. 6 is a partial plan view showing a sealing member for machine tools according to a second embodiment.

FIG. 7A is a perspective view of an L-shaped conventional sealing member for machine tools.

FIG. 7B is a sectional view taken along line C-C of the sealing member for machine tools illustrated in FIG. 7A.

### DESCRIPTION OF EMBODIMENTS

In the following, embodiments of the present invention will be described with reference to the drawings.

### First Embodiment

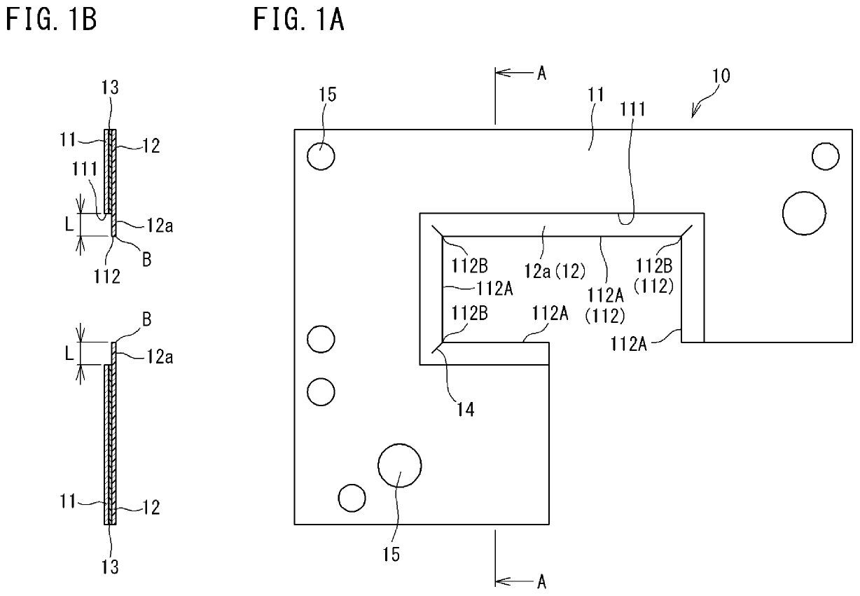

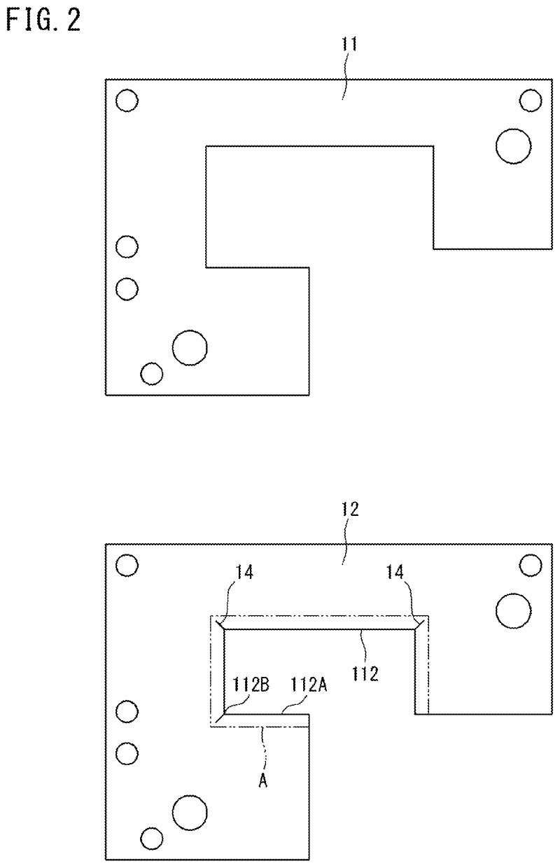

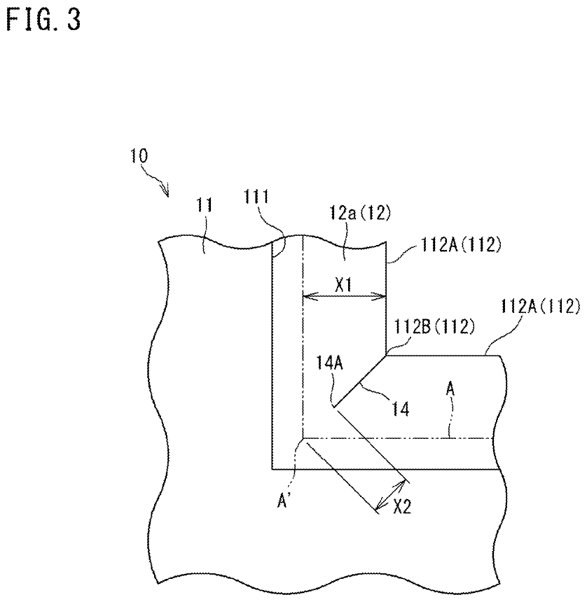

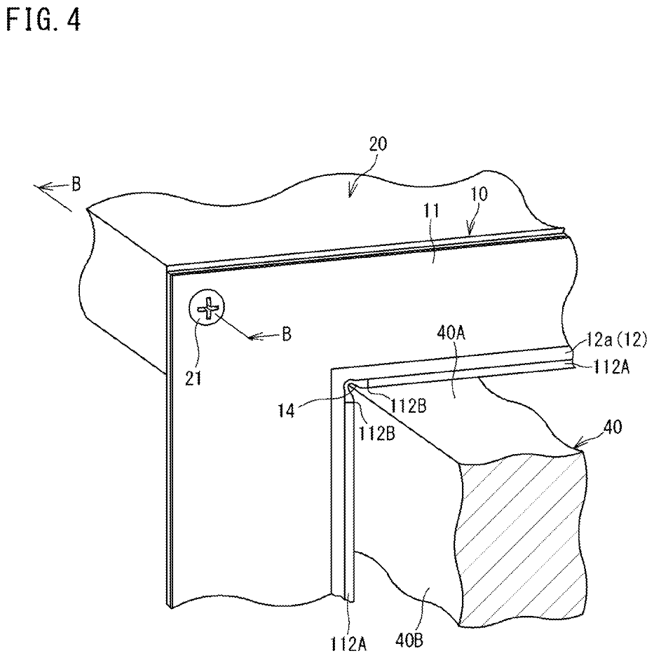

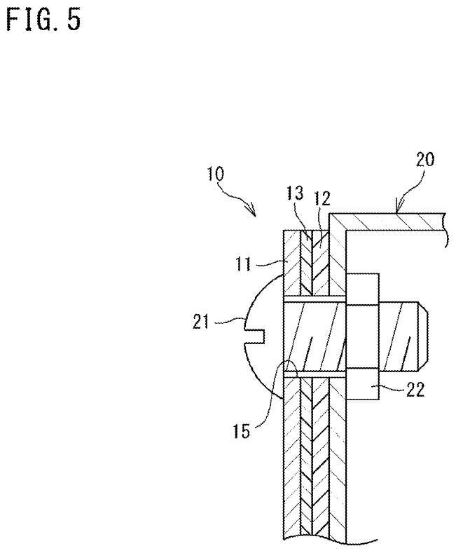

FIG. 1A is a plan view showing a sealing member for machine tools according to a first embodiment. FIG. 1B is a sectional view taken along line A-A of the sealing member for machine tools shown in FIG. 1A. FIG. 2 is a plan view separately showing a supporting member and an elastic member configuring the sealing member for machine tools shown in FIG. 1A. FIG. 3 is an enlarged plan view of a main part of the sealing member for machine tools shown in FIG. 1A. FIG. 4 is a perspective view for explaining a state of contact with a sliding surface of the machine tool when the sealing member for machine tools shown in FIG. 1A is used. FIG. 5 is an enlarged view of a main part of a cross-section taken along line C-C in FIG. 4 for explaining a state of attachment of the sealing member for machine tools.

As shown in FIG. 1A, FIG. 1B and FIG. 2, a sealing member for machine tools 10 according to the present embodiment, which is a polygon, in a plan view, having a plurality of curved portions and bending portions, includes a plate-shaped supporting member 11, and a plate-shaped elastic member 12 having a shape approximate to the supporting member 11 in a plan view. The elastic member 12 is fixed to the supporting member 11 via an adhesive layer 13.

The elastic member 12 includes a projecting portion 12a which projects from an edge portion 111 of the supporting member 11 toward the side of a sliding surface of the machine tool and is fixed to the supporting member 11 via the adhesive layer 13 such that a surface, on a side opposite to the supporting member 11 (the right side in FIG. 1B), of the projecting portion 12a comes into sliding contact with the sliding surface of the machine tool.

The sealing member for machine tools 10 includes a plurality of bolt holes 15. The sealing member for machine tools 10 is attached to a predetermined position of the machine tool using the bolt holes 15.

A distal edge 112 (an edge portion on a side opposite to the supporting member 11) of the projecting portion 12a of the elastic member 12 has a plurality of linear portions 112A (four in the present embodiment) and corner portions 112B (three in the present embodiment) sandwiched between two adjacent linear portions 112A among the plurality of linear portions 112A as shown in the plan views of FIG. 1A and FIG. 2.

Further, the projecting portion 12a is provided with an incision (slit) 14 extending from the corner portion 112B toward the supporting member 11 side.

When attached to an attachment portion of a machine tool, thus configured sealing member for machine tools 10 ensures a pressing margin on one side surface of the projecting portion 12a which is allowed to come into sliding contact (surface-to-surface contact) with the sliding surface of the machine tool, while bringing a sliding contact state of the corner portion 112B and its vicinity with the sliding surface of the machine tool into an appropriate contact state.

As shown in FIGS. 4 and 5, the sealing member for machine tools 10 is attached to an attachment portion 20 of the machine tool using a bolt 21 and a nut 22. At this time, the sealing member for machine tools 10 is attached to the attachment portion 20 of the machine tool such that the elastic member 12 is sandwiched between the attachment portion 20 and the supporting member 11.

In thus attached sealing member for machine tools 10, when the elastic member 12 of the sealing member for machine tools 10 comes into contact with an opposite member 40 of the machine tool having two surfaces curved at 90° as sliding surfaces 40A and 40B as shown in FIG. 4, while the projecting portion 12a of the elastic member 12 is in surface-to-surface contact with the sliding surfaces 40A and 40B, the incision 14 in the corner portion 112B sandwiched between the two linear portions 112A opens. Opening of the incision 14 enables the projecting portion 12a of the elastic member 12 to come into contact with the sliding surfaces 40A and 40B of the opposite member 40 without a gap.

In the sealing member for machine tools according to the embodiment of the present invention, a pressing margin is defined in the following manner. In the above-described sealing member for machine tools, a pressing margin in the linear portion and a pressing margin in the corner portion are defined.

First, a pressing margin in the linear portion of the projecting portion will be described with reference to FIG. 2 and FIG. 3. The pressing margin in the linear portion 112A of the projecting portion 12a is a distance of a part indicated by X1 in FIG. 3. The distance X1 is a distance from a virtual part (see A in FIGS. 2 and 3) to the linear portion 112A, the virtual part coming into contact with the sliding surface of the machine tool without a pressing margin when the sealing member for machine tools 10 is attached to the machine tool.

By contrast, the pressing margin in the corner portion 112B of the projecting portion 12a is a distance indicated by X2 in FIG. 3. The distance X2 is a distance from an end portion 14A, on the side of the supporting member 11, of the incision 14 provided in the projecting portion 12a and a corner portion A′ of the virtual part A.

In the sealing member for machine tools 10, for causing the projecting portion 12a to be in surface-to-surface contact with the sliding surface of the machine tool, the linear portion 112A preferably has a pressing margin X1 of 2.5 mm or more.

The pressing margin X1 is more preferably 3 mm or more. Setting the pressing margin X1 to be 3 mm or more enables the projecting portion 12a to be reliably avoided from inverting at the time of sliding on the sliding surface of the machine tool.

The pressing margin X1 preferably has an upper limit of 15 mm. When the pressing margin X1 exceeds 15 mm, a sliding resistance at the use of the sealing member for machine tools 10 becomes too large in some cases. Additionally, because an edge portion (see B in FIG. 1B) at a front side of the elastic member 12 has a reduced pressure, there might occur a fault such as chips caught between the elastic member 12 and the sliding surface of the machine tool.

The pressing margin X2 in the corner portion 112B of the projecting portion 12a is preferably 2.0 mm or less for avoiding generation of cracks started at the corner portion 112B, the end portion 14A of the incision 14, and the like while allowing contact with the sliding surface of the machine tool.

The pressing margin X2 is more preferably 1.5 mm or less because the crack is less liable to be generated for a long period of time.

The pressing margin X2 need only be 0 mm or more.

The size of the pressing margin X2 can be adjusted by changing a length of the incision 14.

Additionally, the incision 14 is provided from the corner portion 112B toward the corner portion A′ of the virtual part A. In the sealing member for machine tools according to the embodiment of the present invention, the incision is preferably provided in this direction. The incision, however, may not necessarily be provided in this direction as long as the incision is provided from the corner portion sandwiched between two adjacent linear portions toward the supporting member side.

In the sealing member for machine tools 10, a projection length L (a distance between the edge portion 111 of the supporting member 11 and the distal edge 112 of the projecting portion 12a: see FIG. 1B) of the projecting portion 12a that the elastic member 12 has is not particularly limited as long as the projection length is larger than the size of the pressing margin X1.

In the sealing member for machine tools 10, the elastic member 12 preferably has a thickness of 0.5 to 5.0 mm.

When the thickness of the elastic member 12 exceeds 5.0 mm, a pressure of the elastic member 12 becomes so large that as a result, a sliding resistance between the elastic member 12 and the sliding surface of the machine tool becomes too high in some cases. On the other hand, in a case of the thickness of less than 0.5 mm, the pressure of the elastic member 12 becomes too small to obtain sufficient sealability in some cases.

The sealing member for machine tools 10 is configured such that when sliding on the sliding surfaces 40A and 40B of the opposite member 40, the edge portion (see B in FIG. 1B) at the front side of the elastic member 12 also slides while being in contact with the sliding surfaces 40A and 40B. Therefore, a fault such as chips caught between the elastic member and the sliding surface of the machine tool can be avoided.

While the sealing member for machine tools 10 has the corner portions 112B at three positions, the number of the corner portions in the sealing member for machine tools according to the embodiment of the present invention is not particularly limited but need only be at least one. The linear portions need only be provided at two or more positions.

In the sealing member for machine tools according to the embodiment of the present invention, the number and a size of the above linear portions, the number and an angle of the corner portions need only be appropriately selected according to a shape of the sliding surface of the machine tool.

### Second Embodiment

The sealing member for machine tools according to the present embodiment is the same as the sealing member for machine tools according to the first embodiment except that the vicinity of a corner portion in a projecting portion of an elastic member has a different configuration.

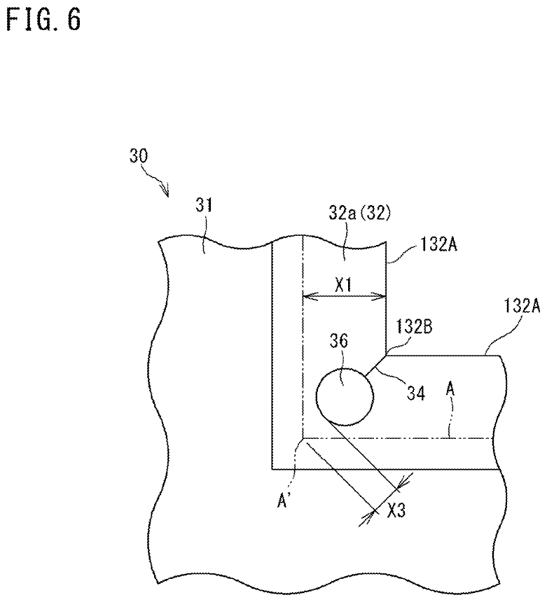

FIG. 6 is a partial plan view showing a sealing member for machine tools according to the second embodiment.

A sealing member for machine tools 30 according to the present embodiment 30 has a through hole 36 provided at a projecting portion 32a of an elastic member 32 fixed to a supporting member 31 via an adhesive layer (not shown) as shown in FIG. 6.

In the projecting portion 32a, the through hole 36 is provided to be positioned between a corner portion 1328 and a corner portion A′ of a virtual part A positioned on the side closer to the supporting member 31 than to the corner portion 132B.

Additionally, the through hole 36 is provided to lead to an end portion of the incision 34 at a side opposite to the corner portion 1328.

Therefore, when the projecting portion 32a is pressed to a sliding surface of the machine tool, the sealing member for machine tools 30 including the through hole 36 has the corner portion 1328 more easily widened. As a result, in the sealing member for machine tools 30, cracks in the corner portion 132B and in its vicinity, damages and the like leading from the corner portion 1328 to a linear portion 132A are less liable to occur.

Additionally, since the through hole 36 includes a wall surface having a columnar shape, stress is hardly concentrated on a specific position during use, resulting in more easily avoiding damages.

A sectional shape (a shape in a direction vertical to a thickness direction of the elastic member) of the through hole is not limited to a circle but need only be polygonal, oval, or other arbitrary shape. Among them, a shape surrounded only by a curved line is preferable in view of the fact that stress is hardly concentrated on a specific position.

In the sealing member for machine tools 30 of the present embodiment, a pressing margin in the corner portion 1328 is a shortest distance between an edge portion of the through hole 36 and the corner portion A′ of the virtual part A, the distance being a distance of a part indicated by X3 in FIG. 6.

An opening diameter of the through hole 36 need only be appropriately adjusted according to a size of X1 and is preferably, for example, 1 to 10 mm.

### OTHER EMBODIMENTS

The sealing member for machine tools according to the embodiment of the present invention need not necessary include an adhesive layer. More specifically, in the sealing member for machine tools, a supporting member and an elastic member may be directly laminated with no adhesive layer interposed therebetween or be attached to an attachment portion of the machine tool in a state of lamination.

As described above, the sealing member for machine tools according to the embodiment of the present invention is attached to an attachment portion of the machine tool such that the elastic member is sandwiched between the attachment portion of the machine tool and the supporting member using a bolt and a nut. Therefore, even without the adhesive layer, the supporting member and the elastic member can be attached to the machine tool in a predetermined state.

A sealing member for machine tools having a supporting member and an elastic member thus laminated with no adhesive layer interposed therebetween facilitates exchange of only the elastic member and reuse of the supporting member.

In the sealing member for machine tools according to the embodiment of the present invention, the elastic member preferably includes an additive (hereinafter also referred to as a μ-lowering agent) composed of an inorganic component etc. for reducing sliding resistance of the sliding surface of the machine tool.

Examples of the μ-lowering agent include particles made from metallic oxides such as cerium oxide, zirconium oxide, titanium oxide, zinc oxide, iron oxide, and silica, and metal such as copper, nickel, iron, and aluminum; hollow particles including silica such as glass balloon or fly ash balloon as a main component; and short-fiber made of metal such as aluminum, stainless steel, and iron, and short-fiber formed from a resin such as polyamide.

As the μ-lowering agent, metallic oxide particles are preferably used, and cerium oxide particles are more preferably used because of being easily fitted to a rubber component (elastomer component) and being chemically stable.

In a case where the elastic member includes a μ-lowering agent, the μ-lowering agent is preferably unevenly distributed in the elastic member on a side, in a thickness direction thereof, which comes into sliding contact with the sliding surface of the machine tool. This is suitable for reducing frictional resistance during sliding while ensuring physical properties (elasticity) of the elastic member.

In a case where the above μ-lowering agent is unevenly distributed in the elastic member in the thickness direction, the side, of the elastic member in the thickness direction thereof, in sliding contact with the sliding surface of the machine tool preferably has a ratio of 0.3 to 0.7 as a ratio of its coefficient of kinetic friction to a coefficient of kinetic friction of an opposite surface in the elastic member.

In a case where the elastic member includes the μ-lowering agent, the μ-lowering agent is preferably dispersed in the elastic member over a plane direction. Reasons of the dispersion will be descried later.

In a case where the elastic member includes a μ-lowering agent being dispersed over the plane direction, a blending amount of the μ-lowering agent is preferably 1.8 to 15 parts by weight relative to 100 parts by weight of a rubber component (elastomer component).

When the blending amount of the μ-lowering agent is less than 1.8 parts by weight, an effect which is to be achieved by including a μ-lowering agent (an effect of reducing sliding resistance) cannot be satisfactorily obtained. By contrast, when the blending amount exceeds 15 parts by weight, the μ-lowering agent easily falls off from the elastic member during sliding, resulting in reducing durability of the elastic member in some cases.

The blending amount of the μ-lowering agent is more preferably 1.8 to 9.5 parts by weight relative to 100 parts by weight of the rubber component (elastomer component).

In the sealing member for machine tools according to the embodiment of the present invention, a pressing margin in each linear portion of the elastic member need not necessarily be the same in the entire sealing member for machine tools. Therefore, a pressing margin may be different in each linear portion. Similarly, a pressing margin in each corner portion need not necessarily be the same in a case where the sealing member for machine tools includes a plurality of corner portions.

Next, constituent members of the sealing member for machine tools will be described.

(Supporting Member)

The supporting member is a plate-shaped member for reliably attaching the sealing member for machine tools to the machine tool while supporting the elastic member.

As a material of the supporting member, although a metal material is in general appropriate such as steel, aluminum or the like in terms of durability and strength, ceramic, rigid plastic, or the like may be used.

Usable as the supporting member are also a surface-untreated steel plate, steel plates whose surfaces are treated with zinc phosphate, chromate, rust-preventing resin and the like, an elastic metallic plate such as phosphor bronze or spring steel.

In a case of fixing the elastic member to the supporting member via an adhesive layer, the supporting member may have a surface treated with a primer and the like in order to improve fittability to the adhesive layer. The supporting member may be also subjected to rough surface-treatment in order to improve adhesiveness to the adhesive layer by an anchor effect.

(Elastic Member)

The elastic member is a plate-shaped member, which comes into sliding contact with the sliding surface of a machine tool when a seal for the machine tool is used, contacts, on one surface side of the projecting portion, with the sliding surface in the machine tool.

Examples of a material of the elastic member include NBR (nitrile-butadiene rubber), urethane elastomer, fluorocarbon rubber, silicone rubber, and EPDM (ethylene propylene diene rubber) because a target in which the elastic member is used is a machine tool and oil resistance is therefore required.

Among these materials, urethane elastomer is preferable because due to excellent durability (wear resistance), desired performance can be maintained for a long period of time.

Examples of the urethane elastomer include a product obtained by allowing polyol, polyisocyanate, and a cross-linker as required to react with each other. Although the urethane elastomer may be thermosetting or thermoplastic, thermosetting urethane elastomer (thermosetting polyurethane) is preferable.

The polyol is not particularly limited and can be, for example, polyester polyol, polyether polyol, polycaprolactonepolyol, or the like.

The polyol preferably has a number average molecular weight of 1000 to 3000. Use of polyol within this range reliably prevents chips, a coolant, etc. from entering during the use.

The number average molecular weight is a polystyrene-based measurement value obtained by GPC (Gel Permeation Chromatography) measurement.

Examples of the polyester polyol include a product obtained by allowing dicarboxylic acid and glycol to react with each other according to an ordinary method.

Examples of the polyether polyol include polyethylene glycol, and polypropylene glycol, and polytetramethylene glycol.

Examples of the polycaprolactonepolyol include a product obtained by ring-opening addition of ε-caprolactone with low-molecular weight glycol as an initiator in the presence of a catalyst.

The polyisocyanate is not particularly limited and conventionally known products can be used which include, for example, aliphatic isocyanate, alicyclic isocyanate, and aromatic isocyanate. Among these products, aromatic isocyanate is preferable in terms of excellent wear resistance.

The polyurethane elastomer can be manufactured by a known method using the above materials, for example, by using, as required, a catalyst in an appropriate organic solvent, allowing the respective materials to react with each other with an equivalent ratio of each material adjusted to NCO/OH=0.9 to 1.1, and allowing the resultant to melt in the absence of a solvent. The polyurethane elastomer can be manufactured also by a method of simultaneously allowing all the materials to react with each other (one-shot method), a prepolymer method, and the like.

As the urethane elastomer, a cured product of a thermosetting urethane composition (thermosetting polyurethane) is preferable which contains a polyol component, an isocyanate component and a cross-linker.

As the thermosetting urethane composition, a thermosetting urethane composition is in particular preferable which includes polyethylene adipate ester polyol (PEA) as the polyol component.

A sealing member for machine tools including an elastic member formed of a cured product of a thermosetting urethane composition containing PEA as a polyol component is less liable to have swelling or elution due to coolant. Therefore, when used for a machine tool which uses a coolant, such a sealing member for machine tools can satisfy required properties even when exposed to the coolant for a long period of time.

The PEA preferably has a number average molecular weight of 1000 to 3000 in view of reliably preventing chips, a coolant, etc. from entering during the use.

The thermosetting urethane composition includes an isocyanate component and a cross-linker other than PEA (polyol component).

The isocyanate component is not particularly limited and can be, for example, aliphatic isocyanate, alicyclic isocyanate, and aromatic isocyanate.

Examples of the aliphatic isocyanate include 1,6-hexamethylene diisocyanate (HDI), 2,2,4-trimethyl hexamethylene diisocyanate, and lysine diisocyanate. The examples also include modified products of an isocyanurate of hexamethylene diisocyanate or isophorone diisocyanate, a biuret and an adduct thereof.

Examples of the alicyclic isocyanate include alicyclic diisocyanates such as isophorone diisocyanate (IPDI), 4,4′-dicyclohexylmethane diisocyanate, 1,4-cyclohexane diisocyanate, and norbornane diisocyanate (NBDI).

Examples of the aromatic isocyanate include tolylene diisocyanate (TDI), phenylene diisocyanate, 4,4′-diphenylmethane diisocyanate (MDI), 1,5-naphthalene diisocyanate (NDI), xylylene diisocyanate (XDI), carbodiimide-modified MDI, and urethane-modified MDI.

These isocyanate components may be used singly or two or more are used in combination.

As the isocyanate component, MDI and NDI are preferable because among aromatic isocyanates, these in particular exhibit excellent wear resistance.

Examples of the cross-linker include 1,4-butanediol (1,4-BD), 1,4-bis(β-hydroxyethoxy)benzene (BHEB), ethylene glycol, propylene glycol, hexanediol, diethylene glycol, trimethylolpropane (TMP), glycerin, 4,4′-methylene bis(2-chloroaniline), hydrazine, ethylenediamine, diethylenetriamine, 4,4′-diaminodi phenyl methane, 4,4′-diaminodicyclohexylmethane, N,N-bis(2-hydroxypropyl) aniline, and water.

Among these cross-linkers, 1,4-butanediol, TMP, and BHEB are preferable because appropriate rubber hardness and rubber rigidity can be exhibited easily. Also, thermosetting urethane compositions including 1,4-butanediol, TMP, and BHEB have a relatively long pot life and can be molded also by manual casting.

The cross-linker may be used singly or two or more are used in combination.

The thermosetting urethane composition may further include reaction aids such as a chain extender, a cross-link accelerator, and a cross-link retarder, hydrolysis inhibitor, and the like as required.

The thermosetting urethane composition preferably has an isocyanate group concentration of 5.50 to 10.0 weight %. In this case, the elastic member can be made to have excellent wear resistance while avoiding hardness of a cured product from becoming too high to increase sliding resistance.

The isocyanate group concentration (weight %) represents a weight ratio of an isocyanate group contained in a total amount of an isocyanate component, a polyol component, and a cross-linker.

Although curing conditions of the thermosetting urethane composition are not particularly limited and can be appropriately set according to the composition of the thermosetting urethane composition, it is a common practice to adopt a condition that the thermosetting urethane composition is heated at 100 to 160° C. for 30 to 90 minutes.

It is also possible to conduct curing processing under the above condition and after releasing the thermosetting urethane composition from a metal mold or the like, conduct post-curing at, for example, 100 to 160° C. for 3 to 48 hours.

The isocyanate component and the polyol component contained in the thermosetting urethane composition may be allowed to react with each other to be a prepolymer before the thermosetting urethane composition is cured under a predetermined condition.

A method of molding the elastic member is not particularly limited and among examples thereof are normal pressure cast molding, reduced pressure cast molding, centrifugal molding, continuous rotation molding, extrusion molding, injection molding, reaction injection molding (RIM), and spin coating.

Among these methods, centrifugal molding and continuous rotation molding are preferable.

In a case where an elastic member is molded by centrifugal molding, a material composition such as a thermosetting urethane composition may be divisionally introduced several times.

In particular, in a case of producing an elastic member containing the g-lowering agent, although the μ-lowering agent is unevenly distributed on one surface side at the time of molding due to centrifugal force or self weight, divisionally introducing a material composition several times enables adjustment of uneven distribution of the μ-lowering agent.

The elastic member preferably has hardness (JIS A hardness) of 55 to 90°.

With the hardness of less than 55°, the elastic member might deform during sliding to fail to satisfactorily prevent chips and the like from entering. On the other hand, when the hardness exceeds 90°, the elastic member is so hard that it might be damaged during sliding. The above elastic member more preferably has hardness of 60 to 75°.

The above JIS A hardness is a value measured by a spring type A hardness testing machine based on JIS K 7312.

In a case where a cured product of the thermosetting urethane composition is adopted as the elastic member, the above JIS-A hardness is preferably 67° or more, and more preferably 70 to 85° in view of ensuring resistance to a coolant.

The elastic member may contain, for example, a hydrolysis inhibiter, a coloring agent such as a pigment, a light stabilizer, a heat stabilizer, an antioxidant, a mildewproofing agent, a flame retardant, and an extender other than the μ-lowering agent.

(Adhesive Layer)

The adhesive layer is not particularly limited and need only be appropriately selected in consideration of a material of each member.

Examples of the adhesive layer include those formed from EVA-based, polyamide-based or polyurethane-based hot-melt adhesive, curable adhesive, and the like, and further include those formed of double-sided adhesive tape.

A thickness of the adhesive layer is not particularly limited but is preferably 50 to 500 μm.

A sealing member for machine tools including such an adhesive layer makes a coolant having passed through a supporting member and an elastic member be less liable to enter. The sealing member for machine tools also facilitates positioning at the time of attachment to the machine tool.

Next, description will be made of a method of manufacturing a sealing member for machine tools with respect to a sealing member for machine tools including an adhesive layer as an example.

The sealing member for machine tools can be manufactured by individually producing such supporting member 11 and elastic member 12 as shown in FIG. 2 and then bonding both the members via the adhesive layer 13 in a predetermined positional relation.

The supporting member 11 can be produced by cutting a steel plate or the like into a predetermined shape.

The elastic member 12 can be produced by cutting a sheet-shaped article formed from thermosetting polyurethane and the like into a predetermined shape. An incision of the elastic member 12 may be provided before the elastic member 12 is bonded to the supporting member 11 or provided after bonding.

Since the sealing member for machine tools can be manufactured by such methods, in a case of dispersing a μ-lowering agent in the elastic member, it is preferable to disperse the μ-lowering agent over the entire plane direction of the elastic member (sheet-shaped article) as described above. This is because when the sheet-shaped article is cut into a predetermined shape, the μ-lowering agent will be constantly present on one surface side irrespective of a cut position.

The sealing member for machine tools according to the embodiment of the present invention can be used, in various machine tools such as a lathe, a machining center, and a cutting machine, as a sealing member (wiper member) for protecting an operation position, a driving mechanism and the like of the machine tool from chips, a coolant, etc.

### EXAMPLES

In the following, the embodiments of the present invention will be further specifically described with respect to Examples. The present invention is, however, not limited to the following Examples.

(Production of Supporting Member and Sheet for Elastic Member)

Production of Supporting Member

A steel plate (Greencote GX-K2, product of Kobe Steel, Ltd.) with a thickness of 0.8 mm was cut by a turret punch to produce the supporting member 11 having the shape shown in FIG. 2.

Production of Sheet for Elastic Member

Urethane sheets A and B were produced by the method shown below.

(Production of Urethane Sheet A)

6.36 parts by weight of 1,4-BD (1,4-butanediol, product of Mitsubishi Chemical Corporation), 0.20 parts by weight of TMP (trimethylolpropane, product of MITSUBISHI GAS CHEMICAL COMPANY, INC.), and 5.00 parts by weight of cerium oxide powder (Cerico CH-BS302, product of Taiyo Koko Co., Ltd.) were added to 100.00 parts by weight of MDI-PEA prepolymer (product name “SANPRENE P-6814”, product of Sanyo Chemical Industries, Ltd.) heated to 110° C., and mixed and stirred to prepare an urethane composition.

Next, the obtained urethane composition was introduced to a centrifugal molding machine and was cross-linked under conditions of a metal mold temperature of 150° C., the number of revolutions of 900 rpm, and a cross-linking time of 50 minutes to mold a cylindrical cured product with a thickness of 1.6 mm, and then, the cured product was released from the mold. Thereafter, the cylindrical cured product had one part thereof cut to be developed into a plate shape, and was subjected to post cross-linking in a ventilation oven under conditions of a temperature of 110° C. and time of 24 hours to produce a urethane sheet A.

Cerium oxide powder was unevenly distributed on one side (a metal mold side at the time of molding) of the urethane sheet A in a thickness direction. The urethane sheet A has a coefficient of kinetic friction of 0.2 on one side surface (the metal mold side at the time of molding) and a coefficient of kinetic friction of 0.4 on the other side surface (an air side at the time of molding).

Accordingly, a ratio of the coefficient of kinetic friction on the one side surface in which the cerium oxide powder was unevenly distributed to the coefficient of kinetic friction on the other side surface was 0.5.

The coefficients of kinetic friction were measured using a surface property tester (Heidon Type 14 (product of Shinto Scientific Co., Ltd.)) under conditions below.

### [Measurement Conditions]

moving speed: 25 mm/sec

opposite material: alumite-treated steel plate

angle: 25°

pressing direction: trailing

length of sample abutting portion: 10 mm

vertical weighting: 100 g

Horizontal weighting during sliding contact was measured and (horizontal weighting/vertical weighting) was considered as a coefficient of friction.

coefficient of static friction: a maximum value at the start of sliding contact

coefficient of kinetic friction: a value obtained when entering a steady state exceeding the maximum value

(Production of Urethane Sheet B)

An urethane sheet with a thickness of 0.7 mm was produced in the same manner as in the production of the urethane sheet A except that an amount of an urethane composition to be introduced was changed.

Next, the two urethane sheets were laminated such that surfaces having a less amount of cerium oxide powder (surfaces on the air side in the centrifugal metal mold) are opposed to each other, thereby forming a urethane sheet B with a thickness of 1.4 mm.

### Example 1

The urethane sheet A produced by the above method was cut into a predetermined external size and was further provided with a predetermined incision to make an elastic member A.

Next, the supporting member and the elastic member A produced by the above method were bonded in a predetermined direction using a double-sided adhesive tape (No. 500, a product of Nitto Denko Corporation) with a width of 5 mm while positioning both the members, thereby producing a sealing member for machine tools 10 having the shape shown in FIG. 1A.

Here, the elastic member A was designed to have a pressing margin X1 in the linear portion of 6 mm and a pressing margin X2 in the corner portion of 0.5 mm.

### Comparative Example 1

The urethane sheet B produced by the above method was cut into a predetermined external size to make an elastic member B.

Next, the supporting member and the elastic member B produced by the above method were bonded using a double-sided tape (No. 500, a product of Nitto Denko Corporation) with a width of 5 mm while positioning both the members, thereby producing a sealing member for machine tools 10 having the shape shown in FIG. 1A.

The elastic member B was, however, designed to have a pressing margin X1 in the linear portion of 0.7 mm and a pressing margin X2 in the corner portion of 0.5 mm.

No incision was provided at the corner portion of the elastic member B.

### Comparative Example 2

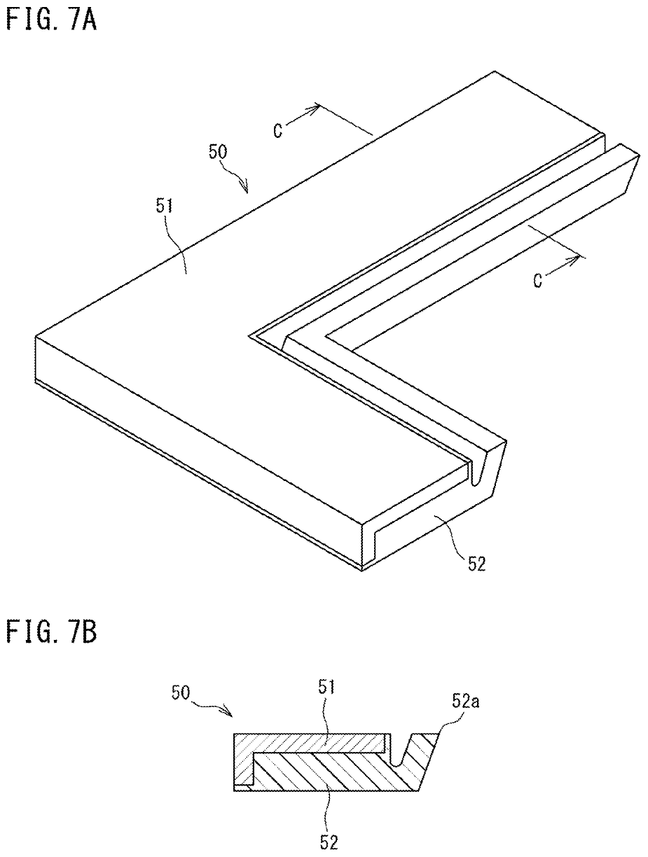

A sliding seal (C-R-3S-R, a product of Bando Chemical Industries, Ltd.) having such a sectional shape as shown in FIG. 7B was used as a sealing member for machine tools for evaluation.

[Evaluation]

The sealing members for a machine tools in Example 1 and Comparative Examples 1 and 2 were attached to a machine tool (cutting machine, a product of TSUNE SEIKI CO., LTD.) to be evaluated. Here, after attaching the sealing member for machine tools to one place of an angular sliding guide portion having a saw head, a cutting machine was driven under conditions below to observe a state of the sealing member for machine tools then. Results are shown in Table

(Drive Conditions of Cutting Machine)

size and the number of revolutions of saw blade: φ400 mm, 100 rpm

advance speed of saw head: 25 mm/sec

retreat speed of saw head: 200 mm/sec

one reciprocation time of saw head: 9.0 sec

(Observation Conditions)

The cutting machine was stopped at a time point where a travelling distance of the sealing member for machine tools reaches 10 km, 15 km, 20 km, 30 km, 40 km, 50 km, 75 km, 100 km, and 150 km to conduct observation of an outer appearance of the sealing member for machine tools and measurement of a pressing margin.

The observation of the sealing member for machine tools of Comparative Example 1 was ended at 30 km and the observation of the sealing member for machine tools of Comparative Example 2 was ended at 20 km.

TABLE 1

| | Example 1 | | Comparative Example 1 | | Comparative Example 2 | |
|---|---|---|---|---|---|---|
| Travelling | | Pressing | | Pressing | | Pressing |
| distance | Outer | margin | Outer | margin | Outer | margin |
| (km) | appearance | (mm) | appearance | (mm) | appearance | (mm) |
| 0 | No | Initial | No | Initial | No | Initial |
| | abnormality | value | abnormality | value | abnormality | value |
| 10 | ↑ | ↑ | Crack at one of | ↑ | Crack at two of | 0.3 |
| | | | corner portions at | | corner portions at | |
| | | | three positions | | three positions | |
| 15 | ↑ | ↑ | ↑ | ↑ | ↑ | ↑ |
| 20 | ↑ | ↑ | ↑ | ↑ | Cracks at all | 0.2 |
| | | | | | corner portions at | |
| | | | | | three positions | |
| 30 | ↑ | ↑ | Cracks at all | ↑ | | |
| | | | corner portions at | | | |
| | | | three positions | | | |
| | | | Rip occurring in | | | |
| | | | linear portion | | | |
| 40 | ↑ | ↑ | | | | |
| 50 | ↑ | ↑ | | | | |
| 75 | ↑ | ↑ | | | | |
| 100 | ↑ | ↑ | | | | |
| 150 | ↑ | ↑ | | | | |

It is clear from the result shown in Table 1 that the sealing member for machine tools according to the embodiment of the present invention enables sealability to be ensured for a long period of time.

### REFERENCE SIGNS LIST

10, 30: SEALING MEMBER FOR MACHINE TOOLS
11, 31: SUPPORTING MEMBER
12, 32: ELASTIC MEMBER
12a, 32a: PROJECTING PORTION
13: ADHESIVE LAYER
14, 34: INCISION
15: BOLT HOLE
20: ATTACHMENT PORTION
21: BOLT
22: NUT
36: THROUGH HOLE
40: OPPOSITE MEMBER
112: DISTAL EDGE
112A, 132A: LINEAR PORTION
112B, 132B: CORNER PORTION
L: PROJECTION LENGTH
X1: PRESSING MARGIN
X2: PRESSING MARGIN
X3: PRESSING MARGIN

1. A sealing member for machine tools, comprising a plate-shaped supporting member and a plate-shaped elastic member, wherein
the elastic member is attached to the machine tool so as to be sandwiched between an attachment portion of the machine tool and the supporting member, the elastic member being in sliding contact with a sliding surface of the machine tool,
the elastic member includes a projecting portion which projects from an edge portion of the supporting member toward a side of the sliding surface of the machine tool, and is configured such that one surface side of the projecting portion comes into sliding contact with the sliding surface of the machine tool, and
the projecting portion has a distal edge including a plurality of linear portions, and a corner portion sandwiched between two adjacent linear portions among the plurality of linear portions, and is provided with an incision extending from the corner portion toward the supporting member side.

2. The sealing member for machine tools according to claim 1, wherein the elastic member preferably includes thermosetting polyurethane and a μ-lowering agent.

3. The sealing member for machine tools according to claim 1, wherein the projecting portion is provided such that a pressing margin of the linear portion is 3 mm or more.

4. The sealing member for machine tools according to claim 1, wherein the projecting portion is provided with a through hole leading to an end portion of the incision at a side opposite to the corner portion.
